(19) United States
(12) Patent Application Publication
(10) Pub. No.: US 2012/0312334 A1
(43) Pub. Date: Dec. 13, 2012

(54) RESIST REMOVAL APPARATUS AND RESIST REMOVAL METHOD

(75) Inventors: Kazuya DOBASHI, Nirasaki City (JP); Takashi FUSE, Fremont, CA (US)

(73) Assignees: Iwatani Corporation, Osaka-shi (JP); Tokyo Electron Limited, Minato-ku (JP)

(21) Appl. No.: 13/594,412

(22) Filed: Aug. 24, 2012

Related U.S. Application Data
(63) Continuation of application No. PCT/JP2011/056170, filed on Mar. 16, 2011.

(30) Foreign Application Priority Data
Mar. 18, 2010 (JP) 2010-062769

(51) Int. Cl. B08B 3/08

(52) U.S. Cl. 134/30; 134/198; 134/172; 134/95.2

(57) ABSTRACT

A resist removal apparatus and method are effective in removing a resist without oxidizing the substrate material other than the resist. The resist removal apparatus, which removes resist from a wafer on which a resist film has been formed, includes a cluster spraying unit which sprays a wafer with clusters each of which is formed of a plurality of organic solvent molecules agglomerated together.

This application is a Continuation Application of PCT International Application No. PCT/JP2011/056170 filed on Mar. 16 2011, which designated the United States.

### FIELD OF THE INVENTION

The present invention relates to a resist removal apparatus and a resist removal method for removing a resist from a substrate on which the resist has been formed.

### BACKGROUND OF THE INVENTION

In a resist removal method for removing an unnecessary resist from a wafer after substrate processing such as etching, doping or the like, a high-temperature SPM (Sulfuric acid/hydrogen peroxide mixture) and an oxygen plasma are mainly used (see, e.g., Japanese Patent Application Publication No. 2007-80850). After the substrate processing such as etching, doping or the like is performed, the chemical structure of the resist is changed and, thus, it is difficult to remove the resist by a cleaning method using solvent or the like. Especially, in the case of a resist formed after high dose ion implantation, a strong cluster layer (carbon rich layer) is formed on the surface of the resist. Accordingly, in the development process, the resist is removed by using a high-temperature SPM, an oxygen plasma or the like.

However, in the case of using a high-temperature SPM, an oxygen plasma or the like, a substrate material other than the resist, e.g., silicon (Si), copper (Cu) or the like, is also oxidized. Therefore, the oxidized portion of the material is etched in a cleaning process to be performed later, which leads to deterioration of the device performance.

### SUMMARY OF THE INVENTION

In view of the above, the present invention provides a resist removal apparatus and a resist removal method, capable of effectively removing a resist by spraying a substrate with clusters of an organic-based solvent, compared to a conventional resist method using a solvent, without oxidizing a substrate material other than the resist.

In accordance with a first aspect of the present invention, there is provided a resist removal apparatus for removing a resist formed on a substrate, including: a cluster spraying unit for spraying the substrate with clusters each of which is formed of a plurality of organic-based solvent molecules agglomerated together.

The resist removal apparatus may include a container accommodating the substrate; a vacuum pump for depressurizing an inside of the container; and a solvent accommodating unit which accommodates an organic-based solvent, wherein the cluster spraying unit includes a supply line for supplying the organic-based solvent from the solvent accommodating unit to the container, and a nozzle for spraying the organic-based solvent supplied through the supply line.

The resist removal apparatus may further include a holding member which holds the nozzle such that the spraying direction of the organic-based solvent is not perpendicular to the substrate; and a moving unit for moving the nozzle held by the supporting member along a surface of the substrate on which the resist has been formed.

The resist removal apparatus may further includes a suction unit for sucking a resist dissolved in or decomposed by the organic-based solvent by the spraying of the clusters.

The resist removal apparatus may further include a unit for ejecting a transfer gas onto the substrate, the transfer gas removing a resist dissolved in or decomposed by the organic-based solvent by the spraying of the clusters and transferring the removed resist to the outside.

In accordance with a second aspect of the present invention, there is a method for removing a resist formed on a substrate, including: spraying the substrate with clusters each of which is formed of a plurality of organic-based solvent molecules agglomerated together; and removing a resist dissolved in or decomposed by the organic-based solvent from the substrate by the spraying of the clusters and transferring the removed resist to the outside.

In the present invention, clusters, each being formed of a plurality of organic-based solvent molecules, are sprayed to the substrate by the cluster spraying unit. Since the clusters sprayed to the substrate are formed of the organic-based solvent molecules, the substrate material other than the resist is not oxidized.

When the clusters formed of the organic-based solvent molecules are sprayed to the resist, the organic-based solvent penetrates into the resist more effectively, compared to the conventional methods using organic-based solvents. When the clusters of the organic-based solvent reach the substrate surface, it is considered that the organic-based solvent molecules are diffused into the substrate surface in a high density state similar to liquid state and also that the resist is swollen and dissolved by the organic-based solvent. Due to the penetration of the organic-based solvent, the resist is dissolved in the organic-based solvent or decomposed by the organic-based solvent, and the connection portion with the substrate is broken. Accordingly, the resist can be removed more effectively compared to the conventional resist removal methods using solvents.

When ion beams of an organic solvent are irradiated to the substrate, the substrate may be damaged by ions and electrons. However, when clusters of organic solvent molecules are sprayed to the substrate, the organic solvent molecules are diffused along the surface of the substrate without damaging the substrate.

In the present invention, the pressure in the container is decreased by the vacuum pump. The nozzle of the cluster spraying unit sprays the organic-based solvent supplied from the solvent accommodating portion through the supply line into the container. The temperature of the organic-based solvent sprayed from the nozzle is decreased due to adiabatic expansion, and the organic-based solvent is clustered. Since the low-temperature clusters are sprayed to the substrate, it is possible to remove the resist from the substrate at a further lower temperature compared to the conventional resist removal methods and prevent oxidation of the substrate material.

In the present invention, the nozzle is held by the holding member such that the spraying direction of the organic-based solvent is not perpendicular to the substrate, and the nozzle can be moved along the substrate by the moving unit. Hence, when the nozzle is moved to the outer side of the substrate while spraying the clusters, the dissolved or decomposed resist can be blown to the outer side of the substrate by the spraying of the clusters.

In the present invention, the suction unit can suck the resist dissolved in or decomposed by the organic-based solvent by the spraying the clusters of the organic-based solvent and then remove the sucked resist from the substrate.

In the present invention, the dissolved or decomposed resist can be blown to the outer side of the substrate by supplying the transfer gas to the substrate.

### Effects of the Invention

In accordance with the present invention, a resist can be removed more effectively, compared to a conventional method using a solvent, without oxidizing a substrate material other than the resist.

### BRIEF DESCRIPTION OF THE DRAWINGS

FIG. 1 is a side cross sectional view schematically showing a configuration example of a resist removal apparatus in accordance with an embodiment of the present invention;

FIG. 2 is a cross sectional view taken along line II-II of FIG. 1;

FIGS. 3A to 3E are explanatory views conceptually showing an example of a resist removal method;

FIGS. 4A and 4B are explanatory views showing difference between spraying of clusters to a substrate and irradiation of ion beams to a substrate;

FIG. 5 is an explanatory view conceptually showing an example of a method for transferring and removing a dissolved or decomposed resist;

FIGS. 6A to 6E are explanatory views conceptually showing an example of a method for removing a resist having a cluster layer;

FIG. 7 is a side cross sectional view schematically showing a configuration example of a resist removal apparatus in accordance with a first modification;

FIG. 8 is an explanatory view conceptually showing an example of a method for transferring and removing a dissolved or decomposed resist in the first modification; and

FIG. 9 is a side cross sectional view schematically showing a configuration example of a substrate cleaning device in accordance with a second modification.

### DETAILED DESCRIPTION OF THE EMBODIMENTS

Hereinafter, embodiments of the present invention will be described in detail with reference to the accompanying drawing which form a part hereof. A resist removal apparatus in accordance with an embodiment of the present invention removes an unnecessary resist from a wafer (substrate) after substrate processing such as etching, doping or the like. Especially, by spraying clusters of a solvent having high affinity for the resist, i.e., an organic-based solvent, to the wafer, the resist can be effectively removed without oxidizing the substrate material other than the resist.

(Resist Removal Apparatus)

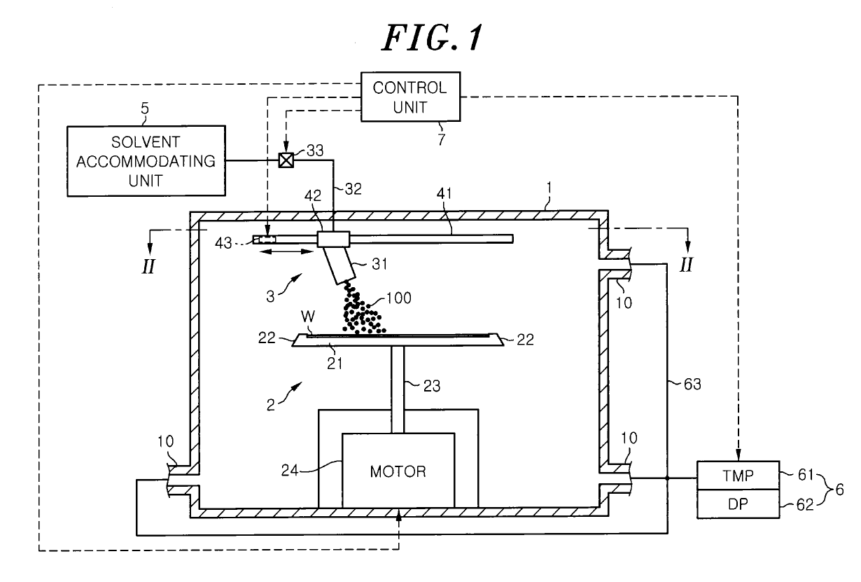

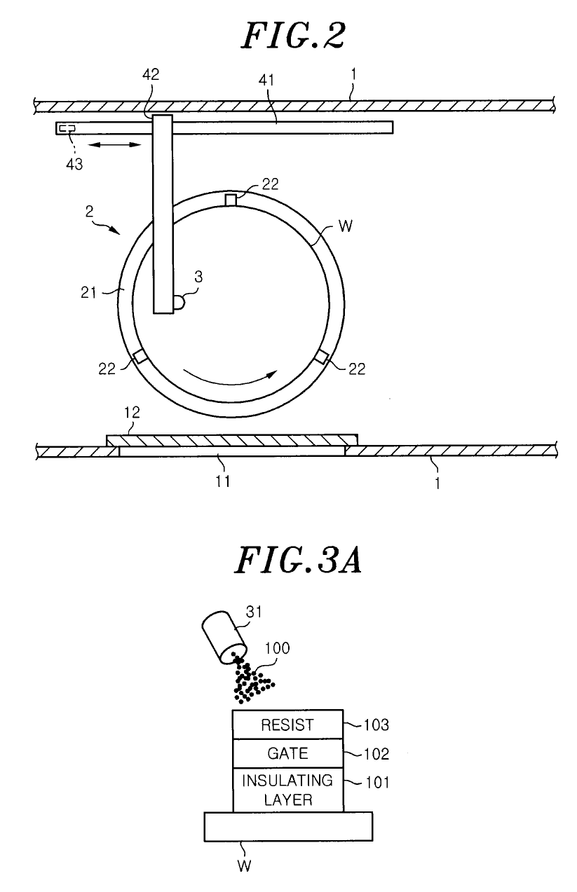

FIG. 1 is a side cross sectional view schematically showing a configuration example of a resist removal apparatus in accordance with an embodiment of the present invention, and FIG. 2 is a cross sectional view taken along line II-II of FIG. 1. The resist removal apparatus of the present embodiment includes a substantially rectangular parallelepiped hollow processing chamber (container) 1 for accommodating a wafer W. As shown in FIG. 2, the processing chamber 1 is provided with a loading/unloading port 11 for loading and unloading the wafer W into and from the processing space in the processing chamber 1. By closing the loading/unloading port 11 with a door body 12, the processing space can be airtightly sealed.

A wafer support 2 for substantially horizontally supporting the wafer W and rotating the wafer W is provided in the processing chamber 1. The wafer support 2 has a table portion 21 on which the wafer W is mounted. As shown in FIG. 2, three holding members 22 are provided on the table portion 21 to substantially horizontally support the wafer W while being in contact with three locations of the circumferential edge of the wafer W. The table portion 21 has a rotation shaft 23 projecting downward from a substantially central portion thereof, and a lower end portion of the rotation shaft 23 is connected to a motor 24 for rotating the table portion 21 about a substantially vertical rotational central axis. When the table portion 21 is rotated by driving the motor 24, the wafer W is rotated together with the table portion 21 on a substantially horizontal plane about a substantial center of the wafer W. In the illustrated example, the wafer W is rotated in a counterclockwise direction when seen from the above. The operation of the motor 24 is controlled by the control unit 7. Although the present embodiment illustrates the configuration in which the table portion 21 is rotated, it is unnecessary to rotate the table portion 21, and the wafer support 2 may not be provided with the motor 24 and the holding members 22.

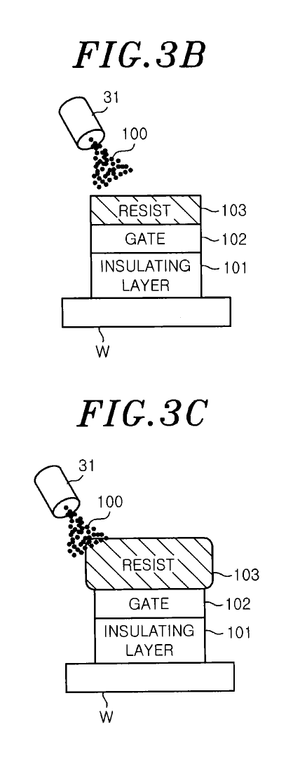

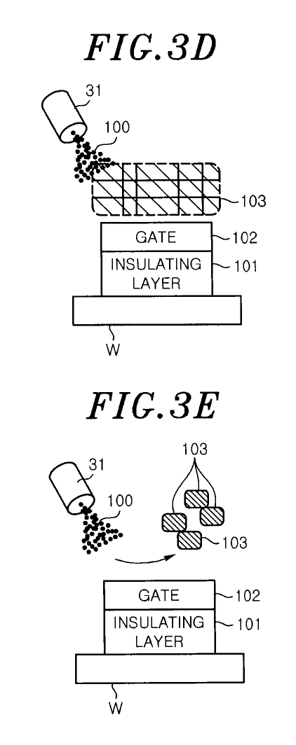

Further, a cluster spraying unit 3 for spraying clusters 100, each being formed of a plurality of agglomerated organic-based solvent molecules having high affinity for the resist 103 (see FIG. 3), to the wafer W is provided at an upper portion of the processing chamber 1. The cluster spraying unit 3 includes a nozzle 31 for spraying an organic-based solvent supplied through a solvent supply line 32 to be described later. When the pressure in the processing chamber 1 is decreased, the organic-based solvent sprayed from the nozzle 31 is clustered by adiabatic expansion. As for the organic-based solvent, it is possible to use, e.g., acetone, isopropyl alcohol, or thinner (resist dissolving agent) such as propylene glycol monomethyl ether, propylene glygol monomethyl ether acetate, butyl acetate, ethyl lactate, ethyl cellosolve acetate, methyl methoxypropionate or the like.

The nozzle 31 is held on a bottom surface of a leading end of a nozzle arm (support member) 42. The nozzle arm 42 is provided above the wafer W supported by the wafer support 2 and holds the nozzle 31 such that the spraying direction of the organic-based solvent is not perpendicular to the wafer W. The base end of the nozzle arm 42 is supported so as to be movable along a guide rail 41 (moving unit) disposed in a substantially horizontal direction. Further, there is provided a driving unit 43 (moving unit) for moving the nozzle arm 42 along the guide rail 41. The guide rail 41 and the driving unit 43 constitute a moving unit for moving the nozzle 31 held by the nozzle arm 42 along the surface of the wafer W where the resist 103 is formed. By driving the driving unit 43, the nozzle arm 42 can be moved, above the wafer W, between diametrically opposite positions outward of the circumferential edge of the wafer W. The operation of the driving unit 43 is controlled by the control unit 7.

The nozzle 31 is connected to the solvent supply pipe (supply line) 32 connected to the solvent accommodating portion 5 which accommodates the organic-based solvent. The solvent supply line 32 is used to supply a gas-phase organic-based solvent in the solvent accommodating portion 5, and an on-off valve 33 is provided in the solvent supply line 32. The opening/closing operation of the on-off valve 33 is controlled by the control unit 7.

Further, gas exhaust ports 10 are provided at proper locations of the processing chamber 1. Each of the gas exhaust ports 10 is connected to the vacuum pump 6 for decreasing the pressure in the processing chamber 1 to, e.g., about 10 Pa, via a line 63. Since the organic-based solvent is clustered by adiabatic expansion, it is preferable to decrease the pressure in the vicinity of the nozzle 31. For example, as shown in FIG. 1, the first gas exhaust port 10 is preferably provided near the nozzle 31, and the second and the third gas exhaust port 10 are preferably provided at lower portions of sidewalls of the processing chamber 1. The vacuum pump 6 includes, e.g., a turbo molecular pump (TMP) 61, and a dry vacuum pump (DP) 62 provided at an upstream side thereof for rough exhaust. The operation of the vacuum pump 6 is controlled by the control unit 7.

(Resist Removal Method 1)

Hereinafter, a method for removing a resist 103 from a wafer W that has been subjected to the formation of the resist 103 and the substrate processing such as etching, ion implantation or the like by using the above-described resist removal apparatus will be described.

FIGS. 3A to 3E schematically explain an example of the method for removing the resist 103. As shown in FIG. 3A, an insulating layer 101, a gate 102 and the resist 103 are formed on the wafer W. First, the control unit 7 controls the vacuum pump 6 to decrease the pressure in the processing chamber 1 to about 10 Pa and controls the operation of the driving unit 43 to move the nozzle 31 to the substantially central portion of the wafer W. Next, the motor 24 is driven to rotate the wafer W mounted on the table portion 21. Then, the control unit 7 opens the on-off valve 33 to supply the organic-based solvent to the nozzle 31. Further, the control unit 7 controls the operation of the driving unit 43 to move the nozzle 31 from the central portion of the wafer W toward the diametrically outer side of the wafer W at a predetermined speed. The organic-based solvent supplied to the nozzle 31 is sprayed toward the wafer W in the processing chamber 1. Since, however, the pressure in the processing chamber 1 is decreased by the vacuum pump 6, the sprayed organic-based solvent is adiabatically expanded. Accordingly, the clusters 100 of organic-based solvent molecules are generated. As shown in FIG. 3A, the generated clusters of the organic-based solvent collide with the resist 103 formed on the wafer W.

The temperature of the wafer W reaches about 80° C. in the case of a conventional method using a high-temperature SPM and about 250° C. in the case of a conventional method using an oxygen plasma. However, in the present embodiment, the temperature of the clusters 100 that reach the wafer W is substantially lower than or equal to a condensation temperature of the organic-based solvent. Therefore, the increase of the temperature of the wafer W can be suppressed. Generally, the increase in the temperature of the wafer W leads to the increase in the removal efficiency of the resist 103 but facilitates the oxidation of other substrate materials. The oxidation of the substrate materials leads to deterioration of the device performance. Accordingly, by using the clusters 100 of the organic-based solvent, the oxidation of the substrate material other than the resist 103 can be suppressed and the device performance can be improved compared to the conventional methods.

Next, the clusters 100 of the organic-based solvent sprayed to the wafer W penetrate into the resist 103 as shown in FIG. 3B, and the resist 103 into which the organic-based solvent penetrates is swollen as shown in FIG. 3C. In FIG. 3C, the portions indicated by oblique lines represent the resist 103 into which the organic-based solvent penetrates. Further, as shown in FIG. 3D, the resist 103 into which the organic-based solvent penetrates into is dissolved in the organic-based solvent or decomposed by the organic-based solvent. Thus, the connection between the resist 103 and the wafer W is broken. The vertical and the horizontal dashed lines in FIG. 3D indicate the state in which the resist 103 is dissolved or decomposed.

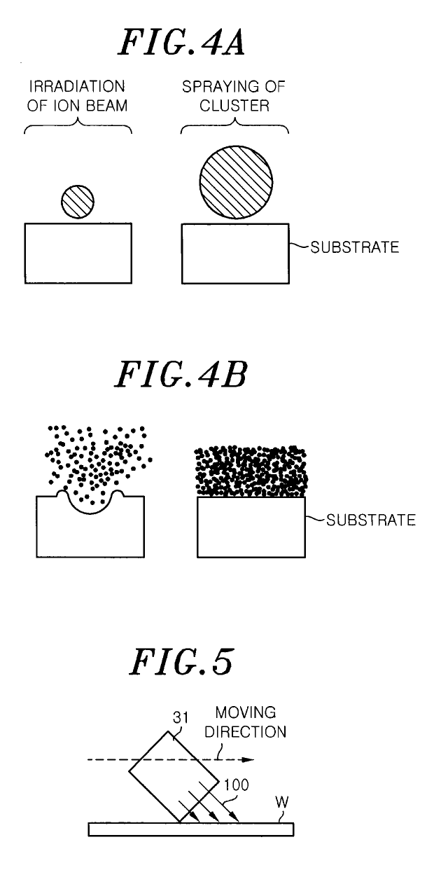

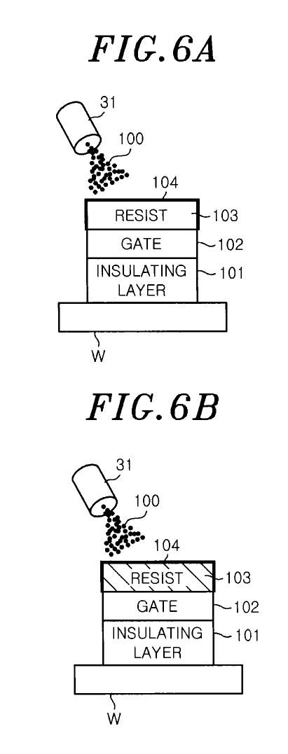

FIGS. 4A and 4B are explanatory views showing difference between spraying of clusters to the substrate and irradiation of ion beams to the substrate. The following is description of simulation showing the state of the substrate and the movement of argon atoms in the case of irradiating ion beams of argon atoms to the substrate or spraying clusters of argon atoms to the substrate. The movement of the ion beams of the organic-based solvent molecules and the clusters 100 of the organic-based solvent molecules is the same as that of the argon atoms. FIGS. 4A and 4B show the substrates before and after the irradiation of ion beams and the spraying of clusters and also show the argon ions and the clusters of argon atoms which are sprayed to the substrate. The left side of FIG. 4A illustrates an ion beam formed of, e.g., about 2000 argon atoms. The ion beam has the energy of about 20 KeV. Therefore, each of the argon atoms forming the ion beam formed of about 2000 argon atoms has the energy of about 10 eV. If the argon atoms of high energy collide with the substrate, the substrate is physically damaged as shown in the left side of FIG. 4B. In addition, the defects of the device and the performance deterioration are caused.

Meanwhile, the right side of FIG. 4A shows clusters of, e.g., about 20000 argon atoms. As in the case of the ion beam, the clusters 100 have the energy of about 20 KeV. Therefore, each of the argon atoms forming the clusters formed of about 20000 argon atoms has the energy of about 1 eV. If the argon atoms of low energy collide with the substrate, the argon atoms are diffused on the surface of the substrate in a high density state similar to liquid without damaging the substrate as shown in the right side of FIG. 4B.

The result of the above simulation shows that when the clusters 100 of the organic-based solvent are sprayed to the wafer W, the organic-based solvent molecules are diffused on the surface of the wafer W in a high density state similar to liquid without damaging the wafer W. Since the organic-based solvent molecules are diffused on the surface of the wafer W in a state similar to liquid, the reaction between the organic-based solvent and the resist 103 is similar to liquid phase reaction, and the resist 103 can be swollen, dissolved or decomposed by the organic-based solvent.

Next, as shown in FIG. 3E, the dissolved or decomposed resist 103 is blown to the diametrically outer side of the wafer W by the clusters 100 of the organic-based solvent sprayed to the wafer W and transferred to the outside of the system.

FIG. 5 schematically explains an example of a method for transferring and removing the dissolved or decomposed resist 103. The nozzle 31 is moved toward the diametrically outer side of the wafer W by the driving unit 43 while spraying the clusters 100 of the organic-based solvent, so that the resist 103 dissolved or decomposed on the wafer W is transferred and removed in the moving direction, i.e., toward the outer side of the wafer W.

(Resist Removal Method 2)

Hereinafter, the method for removing a resist having a cluster layer formed by substrate processing from a wafer W by using the above-described resist removal apparatus will be described.

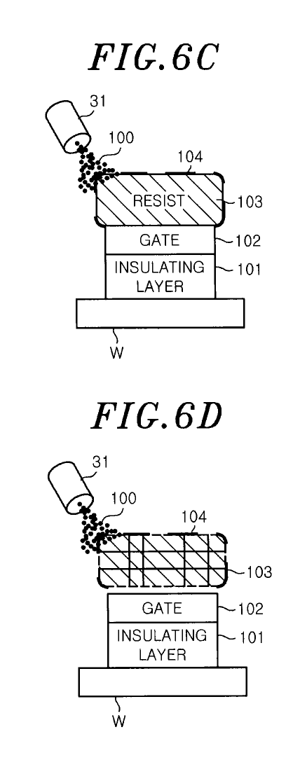

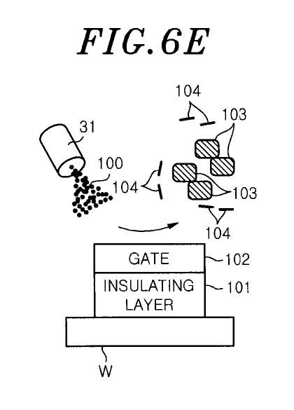

FIGS. 6A to 6E schematically explain an example of the method for removing a resist having a cluster layer. As shown in FIG. 6A, an insulating layer 101, a gate 102 and a resist 103 are formed on the wafer W. Further, a cluster layer 104 is formed on the resist 103 by high dose implantation. The control unit 7 operates the vacuum pump 6, the motor 24 and the driving unit 43 as in the same sequences as those described in FIGS. 3A to 3E. Accordingly, the pressure in the processing chamber 1 is decreased to about 10 Pa, the nozzle 31 is moved to the substantially central portion of the wafer W, and the wafer W mounted on the table portion 21 is rotated. The control unit 7 makes the on-off valve 33 open to supply the organic-based solvent to the nozzle 31 and moves the nozzle 31 from the central portion of the wafer W toward the diametrically outer side of the wafer W. The clusters 100 of the organic-based solvent which are formed by the spraying of the organic-based solvent collide with the resist 103 and the cluster layer 104 formed on the wafer W as shown in FIG. 6A.

As shown in FIG. 6B, the clusters 100 of the organic-based solvent which are sprayed to the wafer W penetrate into the resist 103 even when the cluster layer 104 is provided, and the resist 103 into which the organic-based solvent penetrates is swollen as shown in FIG. 6C. Due to the swelling of the resist 103, the cluster layer 104 is broken. Further, the resist 103 into which the organic-based solvent penetrates is dissolved in the organic-based solvent or decomposed by the organic-based solvent, as shown in FIG. 6D. Accordingly, the connection between the resist 103 and the wafer W is broken.

Then, as shown in FIG. 6E, the dissolved or decomposed resist 103 and the cluster layer 104 are blown toward the diametrically outer side of the wafer W by the clusters 100 of the organic-based solvent which are sprayed onto the wafer W and then transferred to the outside of the system.

In accordance with the resist removal apparatus and the resist removal method of the present embodiment, the resist 103 can be effectively removed from the wafer W, compared to the conventional resist removal method using a solvent, without oxidizing the substrate material other than the resist 103.

Besides, since the clusters 100 of the organic-based solvent of which temperature is decreased by adiabatic expansion are sprayed to the wafer W, the resist 103 can be removed from the wafer W under a lower temperature environment compared to the conventional resist removal method. Hence, the oxidation of the substrate material can be prevented, and the device performance can be improved.

The dissolved or decomposed resist 103 can be removed out of the system by the movement of the nozzle 31 and the spraying of the clusters 100.

Further, since the nozzle 31 is configured to be moved, the processing chamber can be scaled down compared to the case in which the wafer W is moved.

### First Modification

A resist removal apparatus in accordance with a first modification of the present embodiment is configured to transfer the resist 103 to the outside of the system by the transfer gas for transferring the resist 103 dissolved or decomposed by spraying the clusters of the organic-based solvent. The resist removal apparatus of the first modification is the same as the above-described embodiment except the configuration related to the nozzle 31 and the transfer gas supply, so that only the differences will be described hereinafter.

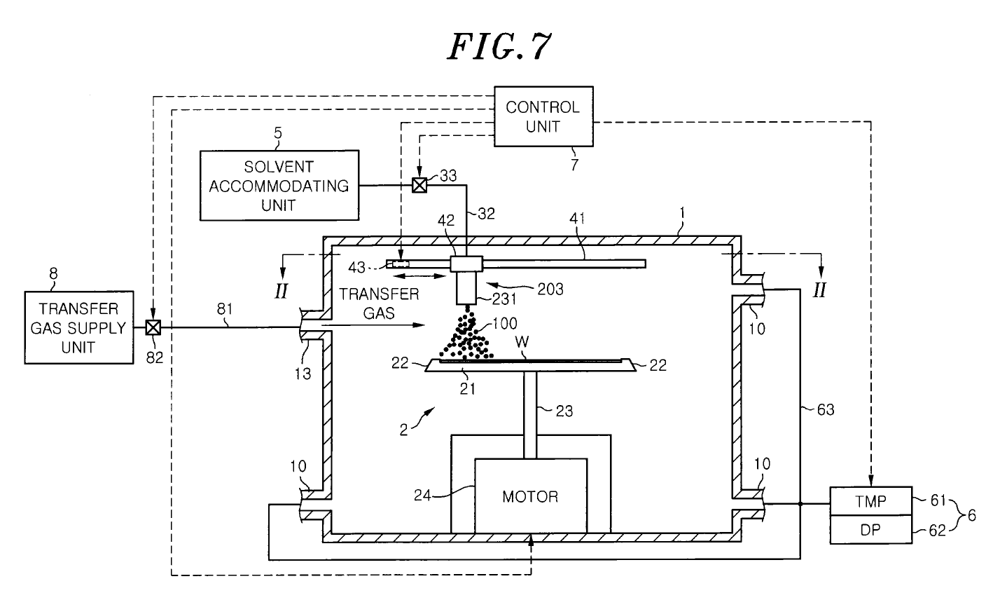

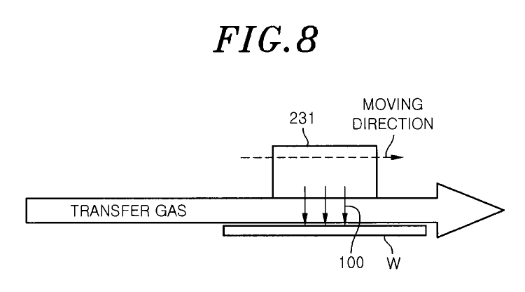

FIG. 7 is a side cross sectional view schematically showing an example of a configuration of the resist removal apparatus in accordance with the first modification. A nozzle 231 of a cluster spraying unit 203 forming the resist removal apparatus in accordance with the first modification is supported by a nozzle arm 42 such that the spraying direction of the organic-based solvent is substantially perpendicular to the wafer W. The resist 103 can be more effectively dissolved and decomposed when the organic-based solvent is sprayed in a direction substantially perpendicular to the wafer W compared to when it is sprayed in oblique directions.

In addition, a transfer gas ejection port 13 for ejecting a transfer gas onto the surface of the wafer W is formed at a proper location of the sidewall of the processing chamber 1. The transfer gas transfers the resist 103 to the outside of the system. For example, the transfer gas ejection port 13 may be provided at a portion facing the gas exhaust port 10 disposed above the table portion 21. With such configuration, the transfer gas flows along the surface of the wafer W and is exhausted to the outside of the processing chamber 1, which makes it possible to effectively remove the resist 103. The gas exhaust port 10 is connected to a transfer gas supply line 81. The transfer gas supply line 81 is connected to a transfer gas supply unit 8 for supplying a transfer gas such as argon gas, nitrogen gas or the like. The transfer gas supply unit 8 is, e.g., a gas cylinder that accommodates argon gas, nitrogen gas or the like.

The transfer gas supply unit 8 is provided with an on-off valve 82. The opening/closing operation of the on-off valve 82 is controlled by the control unit 7. Although the opening/closing timing of the on-off valve 82 is not particularly restricted, it is preferable to employ, e.g., a configuration in which the on-off valves 33 and 82 are alternately opened and closed by the control unit 7. By alternately performing the spraying of the clusters of the organic-based solvent and the removal of the resist 103 dissolved or decomposed by the spraying of the clusters, it is possible to prevent the spraying of the clusters 100 to the wafer W from being disturbed by the flow of the transfer gas and also possible to effectively remove the resist 103. In addition, the irradiation of the clusters 100 of the organic-based solvent and the supply of the transfer gas can be performed at the same time by optimizing the flow rate of the transfer gas.

FIG. 8 conceptually explains an example of a method for removing and transferring the dissolved or decomposed resist 103 in the first modification. The transfer gas supplied into the processing chamber 1 by opening the on-off valve 82 flows along the surface of the wafer W and is exhausted from the gas exhaust ports 10. The resist 103 dissolved or decomposed by the spraying of the clusters of the organic-based solvent is transferred to the outside of the system 103 while being carried by the transfer gas.

In accordance with the resist removal apparatus and the resist removal method of the first modification, the resist 103 can be more effectively removed by spraying the organic-based solvent to the wafer W in a direction substantially perpendicular thereto. Further, the dissolved or decomposed resist 103 can be effectively transferred to the outside of the wafer W by supplying the transfer gas to the wafer W.

### Second Modification

A resist removal apparatus in accordance with a second modification is configured to transfer a wafer while fixing a cluster spraying unit to a processing chamber and transferring the part of the wafer W. Moreover, the resist removal apparatus in accordance with the second modification is provided with a suction member (suction unit) for sucking the resist removed by spraying of clusters. The resist removal apparatus in accordance with the second modification is different from the above-described embodiment except such configuration. Therefore, only the differences will be described hereinafter.

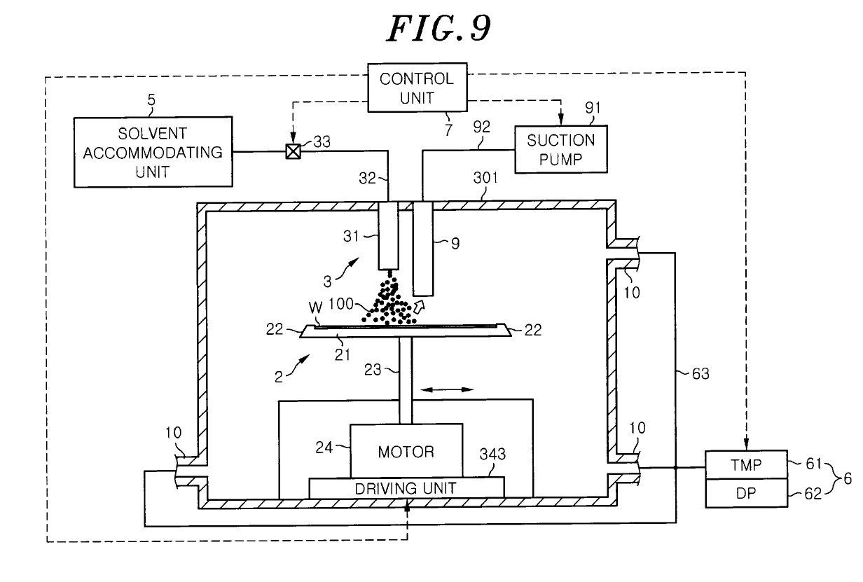

FIG. 9 is a side cross sectional view schematically showing a configuration example of the resist removal apparatus of the second modification. The resist removal apparatus in accordance with the second modification includes a processing chamber 301 in which a nozzle 31 of a cluster spraying unit 3 is fixed to a substantially central portion of a ceiling plate thereof. Further, a suction member 9 for sucking a resist removed by the spraying of clusters is fixed to the ceiling plate of the processing chamber 301, and the nozzle 31 and the suction member 9 are installed side by side. The suction member 9 is connected to a suction pump 91 via a suction line 92. A driving unit 343 for transferring the table portion 21 in a horizontal direction together with the motor 24 is provided at a bottom portion of the processing chamber 301. The driving unit 343 can transfer the table portion 21 within the range in which the entire surface of the wafer W can be scanned by the cluster spraying unit 3. The processing chamber 301 has a horizontal width required to transfer the table portion 21 within the range in which the entire surface of the wafer W can be scanned by the cluster spraying unit 3.

In the second modification, the nozzle 31 is fixed to the ceiling plate of the processing chamber 301. Therefore, it is possible to reduce the possibility in which the wafer W is contaminated by particles from the driving unit 343, compared to the embodiment.

Further, the transfer gas supply port may be provided at the processing chamber in accordance with the second modification. In that case, the resist can be removed more effectively.

The above embodiments have been described for illustrative purpose only and the present invention is not limited thereto. The scope of the invention is disclosed in the accompanying claims and thus is not restricted by the above embodiments. Further, the accompanying claims and their equivalents are intended to cover various modifications.

What is claimed is:

1. A resist removal apparatus for removing a resist formed on a substrate, comprising:
a cluster spraying unit for spraying the substrate with clusters each of which is formed of a plurality of organic-based solvent molecules agglomerated together.

2. The resist removal apparatus of claim 1, comprising:
a container accommodating the substrate;
a vacuum pump for depressurizing an inside of the container; and
a solvent accommodating unit which accommodates an organic-based solvent,
wherein the cluster spraying unit includes a supply line for supplying the organic-based solvent from the solvent accommodating unit to the container, and a nozzle for spraying the organic-based solvent supplied through the supply line.

3. The resist removal apparatus of claim 2, further comprising:
a holding member which holds the nozzle such that the spraying direction of the organic-based solvent is not perpendicular to the substrate; and
a moving unit for moving the nozzle held by the supporting member along a surface of the substrate on which the resist has been formed.

4. The resist removal apparatus of claim 1, further comprising a suction unit for sucking a resist dissolved in or decomposed by the organic-based solvent by the spraying of the clusters.

5. The resist removal apparatus of claim 1, further comprising a unit for ejecting a transfer gas onto the substrate, the transfer gas removing a resist dissolved in or decomposed by the organic-based solvent by the spraying of the clusters and transferring the removed resist to the outside.

6. A method for removing a resist formed on a substrate, comprising:
spraying the substrate with clusters each of which is formed of a plurality of organic-based solvent molecules agglomerated together; and
removing a resist dissolved in or decomposed by the organic-based solvent from the substrate by the spraying of the clusters and transferring the removed resist to the outside.
